(19) United States
(12) Patent Application Publication
(10) Pub. No.: US 2005/0193553 A1
(43) Pub. Date: Sep. 8, 2005

(54) Method and device for joining at least two parts

(75) Inventors: Andreas Schubert, Dresden (DE); Sven Hochmann, Dresden (DE); Ralf God, Dresden (DE); Jorg Schneider, Chemnitz (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Muhlbauer AG, Roding (DE)

(21) Appl. No.: 11/106,121

(22) Filed: Apr. 14, 2005

Related U.S. Application Data
(63) Continuation of application No. PCT/EP03/11430, filed on Oct. 15, 2003.

(30) Foreign Application Priority Data
Oct. 15, 2002 (DE) 102 48 020.6

(51) Int. Cl. H01P 11/00

(52) U.S. Cl. 29/729; 29/600

(57) ABSTRACT

At least two components are brought to rest on each other at least in an assembly portion, with a carrier element contacting a first one of the two components at least in the assembly portion, and at least one projection passing through the components in the assembly portion in the direction towards the carrier element. The carrier element is planarly supported at least in the assembly portion against the passing-through movement of the projection, and the passing of the projection through the components. The opposed planar support of the carrier element effects a plastic deformation of the passed-through material of the components in the direction transversely to the passing-through movement of the projection by deforming the carrier element.

### CROSS-REFERENCE TO RELATED APPLICATIONS

This application is a continuation of International (PCT) Application No. PCT/EP2003/011430, filed on Oct. 15, 2003 which claims priority on German Application Serial No. 102 48 020.6, filed on Oct. 15, 2002, the entire contents of each of which is incorporated herein by reference.

### BACKGROUND OF THE INVENTION

1. Field of the Invention

The present invention refers to a method and a device for assembling at least two components. The present invention particularly refers to a method for assembling at least two thin foils.

2. Description of Related Art

It is required to connect two foils to one another in various technical fields. In the field of radio frequency identification, so-called RFID-data carriers in the form of RFID-labels are for instance used, which consist of a flexible antenna substrate with a metal coating and pre-assembled RFID chips on metal foil bridges. The different foils, which carry the elements, are connected to one another. Usually, connection techniques such as adhesion, electron-beam welding, ultrasonic welding, bonding or soldering are used.

If sheets with a greater thickness are used, plastic deformation assembling methods are used, wherein a mechanical connection between the two sheets by plastic deformation of the same is achieved usually in multi-stage methods. These methods are known as clinching.

Most methods in the field of clinching have in common that two sheets resting on each other are plastically deformed by an assembling die. In this plastic deformation process, the material of the two sheets is deformed such that a type of protuberance is formed for both sheets. By appropriately formed counterholders or dies and by the shape of the assembling die or the movement of the assembling die (such as a wobble movement) an undercut portion is formed in which the two sheets in the assembling portion are given a special, 3-dimensional shape. A mushroom-like protuberance is created by the massive plastic deformation of the two sheets in the assembling portion, said protuberance forming a positive connection between the sheets due to the undercut. In a further field of clinching, said protuberance is upset back during a second stage, thus forming a positive and force-fit folding which connects the two sheets to one another.

### SUMMARY OF THE INVENTION

It is the object of the present invention to provide a method and an apparatus for assembling at least two components, wherein the assembly can be carried out in a simple and reliable manner.

According to the method aspect, this object is solved according to the invention by a method for assembling at least two components, which contact each other at least in an assembly portion, wherein a carrier element contacts the first one of the two components at least in the assembly portion, at least one projection passes through the components in the assembly portion in the direction towards the carrier element, the carrier element is planarly supported at least in the assembly portion against the passing through movement of the projection, and the passing through of the projection by the components and the opposite planar support of the carrier element effect a plastic deformation of the passed-through material of the components in the direction transversely to the passing-through movement of the projection by deformation of the carrier element.

According to a preferred embodiment, the carrier element consists of an elastically and/or plastically-deformable material.

It is preferred that the projection first of all penetrates into a second component and displaces material of the second component in the direction towards the first component, and is displaced by a continuation of the passing-through movement of the projection material of the first component in the direction towards the carrier element, and the displaced material of the first and the second component substantially penetrates into the carrier element, wherein the plastic deformation of the passed-through material of the components transversely to the passing-through movement forms an undercut portion with the first and the second component.

In an especially preferred manner, the projection when passing through the components carries out a partial cutting process at both components along at least one line.

According to a preferred embodiment, the cutting process is carried out along at least one straight line. The cutting process can also be implemented along two parallel straight lines. However, the shape of the cutting line is freely selectable, at least as long and as far the undercut is not obstructed.

In an especially preferred manner, the passing-through movement of the projection is carried out in one single continuous stroke movement.

It is preferred that the planar support of the carrier element is implemented in a plane. In a preferred manner the support of the carrier element is implemented across a large surface.

According to a preferred embodiment, the components are at least a first and a second foil or comprise at least a first and a second foil section, which contact each other at least in the assembling portion.

According to an embodiment it is possible, but not compulsory, that the first and the second foil or the first and the second foil section rest on each other across a large surface.

It is preferred that the foils or foil sections comprise paper and/or plastic and/or metal. It is preferred that the foils and foil sections are uncoated or coated and/or have a sandwich structure.

According to a preferred embodiment, the foils or the foil sections have a thickness in a range larger than 0 μm to approx. 300 μm.

In a preferred manner, the first and the second foils are connected two each other at least in some portions particularly by adhesion and/or welding before they are assembled. An assembly of the two or more foils without previous adhesion is, however, also conceivable. A previous adhesion increases in an advantageous manner the great holding forces of the connection according to the invention. According to a further preferred embodiment, a first foil has an electrically conductive layer. The electrically conductive layer of the first foil and the electrically conductive layer of the second foil are electrically insulated against each other, and by the passing-through movement of the projection in the assembly portion of the first and the second foil, an electrical contact between the electrically conductive layer of the first foil and the electrically conductive layer of the second foil is created.

In a preferred manner, the carrier element consists of a carrier foil, which at least in the assembly portion contacts the first foil. In a preferred manner, the first foil and the carrier foil rest on each other across a large surface.

In the previously described method, the carrier foil preferably comprises paper and/or plastics and/or metal. The carrier foil may be uncoated or coated and/or have a sandwich structure. It is desirable that the carrier foil has a thickness in a range larger than 0 μm to approx. 300 μm.

It is also possible that before assembly, the carrier foil is connected to the first foil at least in some portions in an adhesive manner, particularly by adhesion and/or welding. The first foil is coated preferably at least in the assembly portion with the carrier foil.

In an especially preferred manner, the assembly portion of the first and second foil has a size of approx. 1 mm².

According to a preferred embodiment, the projection is formed as a microstructure on an assembly die or a counterholder.

According to a preferred embodiment, the microstructure has a width and a height smaller than 1 mm.

In a preferred manner the projection is formed in a catwalk-like manner. In a preferred embodiment, a plurality, particularly three, projections for one single assembly portion for the parallel passing-through of material are provided. According to a preferred embodiment, at least two, preferably three, catwalk-shaped projections are provided in parallel to each other for one single assembly portion.

It is advantageous if the introduction of force onto the projections is implemented abruptly via a die and/or a counterholder.

According to the apparatus aspect, this object is solved according to the invention by a device for assembling at least two components, which contact each other at least in an assembly portion, comprising at least one projection and an opposing counterholder, wherein the projection is provided for passing through the components in the assembly portion, a carrier element is provided between a first one of the two components and the counterholder and contacts the first component and the counterholder at least in the assembly portion, and the counterholder is provided for the planar support of the carrier element at least in the assembly portion against the passing-through movement of the projection, and the passing of the projection through the components and the opposed planar support of the carrier element effects a plastic deformation of the passed-through material of the components in a direction transversely to the relative movement of the projection by deforming the carrier element.

In the assembly apparatus it is preferred that the carrier element consists of an elastic and/or plastically deformable material.

In a preferred manner, the projection is movable relative in the direction towards the counterholder.

According to a preferred embodiment of the assembly apparatus, the projection comprises at least one cutting edge to carry out a partial cutting process at both components along at least one line during the passing-through movement. In a preferred embodiment, the cutting edge is straight. It is preferred that the projection has two parallel cutting edges, wherein the cutting edges can be connected by further cutting edges, having any design, e.g. by means of a straight line or a circular arc.

In a preferred manner, the counterholder is formed as a planar counterholder plate which can be contacted with the carrier element.

Concerning the assembly apparatus it is preferred that the components are at least a first and a second foil or comprise at least a first and a second foil section, which rest on each other at least in the assembly portion, and the carrier element consists of a carrier foil, which at least in the assembly portion contacts the first foil. It is also possible that the first foil (in this portion) is coated by the carrier foil.

It is preferred that the carrier foil comprises paper and/or plastic material. It is also preferred that the carrier foil is uncoated or coated and/or has a sandwich structure. It is preferred that the carrier foil has a thickness in a range larger than 0 μm to approx. 300 μm.

According to a preferred embodiment of the assembly apparatus, the projection is formed as a microstructure on a movable assembly die or the counterholder.

In the assembly apparatus it is preferred that the movable assembly die is guided in a downholder.

According to a preferred embodiment of the assembly apparatus, the microstructure has a width and a height less than 1 mm. It is preferred that the assembly portion has a size of approx. 1 mm².

In a preferred manner the projection is formed in a catwalk-like manner. It is preferred in the assembly apparatus that a plurality, particularly three, of projections for one single assembly portion for the parallel passing-through of material are provided. According to a preferred embodiment, at least two, preferably three, catwalk-shaped projections are provided in parallel to each other for one single assembly portion.

The present invention will now be described closer and explained by means of an embodiment in connection with the attached drawings.

### BRIEF DESCRIPTION OF THE DRAWINGS

FIG. 1 shows the schematic view of an apparatus for assembling two components according to an embodiment, and

FIG. 2 is a sectional view of an assembled connection.

### DETAILED DESCRIPTION OF THE INVENTION

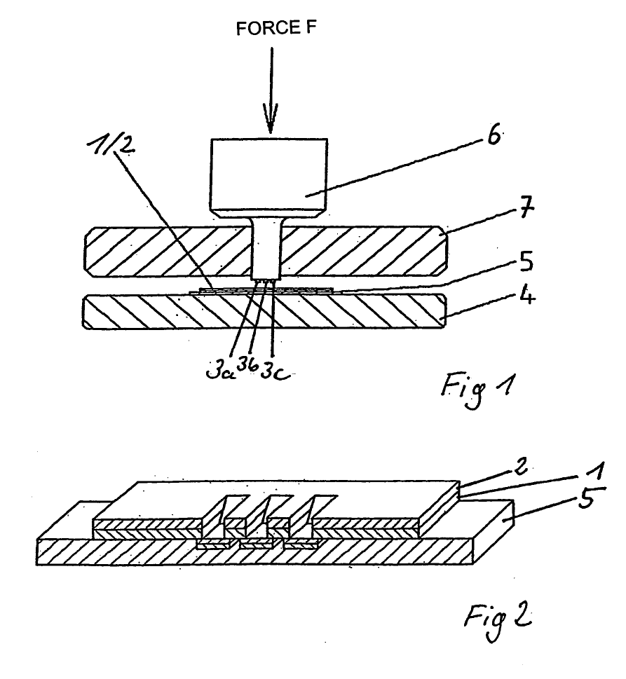

FIG. 1 shows the device for assembling two components. According to the embodiment shown, two plate-shaped components in the form of two foils 1, 2 are shown in the assembling apparatus. These foils 1, 2 rest on each other at least in the assembly portion. A first foil 1 rests on a carrier foil 5, which serves as a carrier element. The carrier foil 5 in turn rests on a plate-shaped anvil, which is formed as a counterholder 4. The plate-shaped anvil comprises a planar counterholder surface.

A downholder 7 and an assembly die 6 are provided opposite to the second one of the two foils 1, 2. The assembly die 6 is arranged axially movably in an opening of the downholder 7. The movable assembly die 6 is guided in the downholder 7. The downholder 7 comprises a planar downholder surface. The downholder 7 is movable in the direction towards the die movement and is brought to rest on the second foil 2. The first foil 1, the second foil 2, the carrier foil 5, the counterholder surface of the anvil 4 and the downholder surface of the downholder 7 are arranged substantially in parallel to each other, as shown in FIG. 1.

In the apparatus for assembling the two foils 1, 2, these foils are brought to rest on each other at least in the assembly portion. The assembly die 6 has projections 3a-c, which extend in the direction towards the anvil formed as a counterholder 4. The projections 3a-c are formed as a microstructure on the movable assembly die 6. In the embodiment shown, three projections 3a, 3b, 3c are used. The microstructure (the three projections) has a width and a height of less than 1 mm.

As an alternative to the embodiment shown, the microstructure may be formed on the counterholder. In this case, the assembly die is formed with a planar counter surface, and the foils 1, 2 and 5 are arranged in opposite order.

In both cases is the counter piece to the microstructure not formed as a die, i.e. with a special counter-shape, but preferably flat or planar. The structure of the installation is substantially simplified thereby and therefore forms the basis of a high process safety.

The projections 3a-c are provided for passing through the two foils 1, 2 in the assembly portion. The carrier foil 5 is provided between the first foil 1 and the counterholder 4. The assembly die 6 with the projections 3a-c is moved along its longitudinal axis on the foils 1, 2 and 5 and carries out a passing-through movement relative in the direction towards the counterholder 4, as will be explained in detail later on.

The counterholder 4 supports the carrier foil 5 in the assembly portion against the passing-through movement of the projections 3a-c. The passing of the projections 3a-c through the foils 1, 2 and the opposed planar support of the carrier foil 5 effect a plastic deformation of the material of the foils 1, 2 passed through in the direction transversely to the relative movement of the projections 3a-c. The carrier foil 5 is deformed, i.e. displaced, accordingly.

The carrier foil 5 consists of an elastic and/or plastically deformable material. The carrier foil 5 for instance comprises paper and/or plastics and/or metal. The carrier foil 5 may be uncoated or coated and/or may have a sandwich structure.

According to the embodiment, the projections 3a-c each comprise cutting edges. These cutting edges carry out a partial cutting process at both foils 1, 2 during the passing-through movement, as shown in FIG. 2. Each of the projections 3a-c comprises two parallel straight cutting edges. The carrier foil 5 has a thickness in a range larger than 0 μm to approx. 300 μm.

The apparatus for assembling the foils 1, 2 defines the assembly portion with a size of approx. 1 mm². The assembly portion is defined by the projections 3a-c in the microstructure. In the embodiment shown, three web-shaped projections 3a-c are provided in parallel to one another for one single assembly portion.

When assembling the foils 1, 2, these foils are connected to one another at a plurality of assembly portions, for instance to manufacture an RFID label. The foils 1, 2 are positioned relative to the assembly die 6. For this positioning, the anvil 4 is movable together with the foils 1, 2 and 5 in the plane parallel to the foils to position the individual assembly portions underneath the assembly die 6. The assembly die 6 and the downholder 7 are fixed with respect to said plane and can only be moved perpendicularly with respect to the plane.

As an alternative, the assembly die 6 and the downholder 7 may also be formed movable in the plane parallel to the foils in order to position the assembly die 6 over the single assembly portion. The anvil 4 is fixed with respect to said plane.

A further alternative provides the displacement of the foils 1, 2 and 5 between a fixed anvil and a fixed die. This can be implemented manually, partially automated and fully automated.

The movement of the anvil 4 or of the assembly die 6 in the plane in parallel to the foils 1, 2 is controlled by a control means (not shown) and is synchronized with the passing-through movement of the assembly die 6. This assembly process is carried out fully automatically or partially automatically.

In order to increase the process speed, the assembly die 6 and the downholder 7 as well as the anvil 4 may be movable in the plane parallel to the foils. This overlapped movement shortens the positioning time between two assembly processes and is controlled fully automatically by a control means.

The method of assembling two foils 1, 2 will now be described in more detail. The two foils 1, 2 rest on each other at least in an assembly portion. In the embodiment shown, the foils are put onto each other on a large surface. The two foils 1, 2, are laid onto the carrier foil 5 and this foil package is inserted into the above-mentioned apparatus. The foil package rests with a large surface on the counter-surface of the anvil 4. The carrier foil 5 is arranged between the first foil 1 and the anvil, as shown in FIG. 1.

The assembly die 6 is moved towards the foil package, wherein the projections 3a-c penetrate into the second foil 2 and displace material of the second foil 2 towards the first foil 1. At the same time, material of the first foil 1 is displaced towards the carrier foil 5. The projections 3a-c press the displaced material of the second carrier foil 2 onto the first foil, which causes the displaced material of the first foil 1 to penetrate into the carrier foil 5 to displace material of the carrier foil 5. By the planar counterholder-surface of the anvil 4, the carrier foil 5 is supported against the movement of the assembly die 6 (the movement of the projections) so that a further displacement of material towards the movement of the assembly die 6 is substantially prevented.

During the displacement of the material of the second and the first foil 1, 2 towards the movement of the assembly die 6 with the force F, the assembly die 6 (the projections 3a-c) carries out a passing-through movement. As shown in FIG. 2, the material of the second foil 2, which is displaced by the projections 3a-c, is displaced toward the counterholder 4 to such an extent that a section of this displaced material of the second foil 2 is substantially completely outside the plane of the first foil 1 and substantially fully within the carrier foil. Accordingly, a section of the displaced material of the first foil 1 is displaced far into the carrier foil 5.

The planar counterholder surface of the anvil 4 supports the carrier foil against the passing-through movement of the assembly die 6 (the passing-through movement of the projections). This prevents a further displacement of material towards the movement of the assembly die 6. The passing-through movement of the assembly die is, however, continued with the predetermined force F so that a plastic deformation of the material of the foils 1, 2 passed-through occurs transversely to the passing-through direction and an undercut portion is formed with the first and the second foil 1, 2, as is shown in FIG. 2. By the transverse squeezing of the displaced material of the second and the first foil 1, 2 in the carrier foil 5, a positive connection of the foils 1, 2 in the assembly portion is created.

The passing-through movement of the assembly die 6 explained is carried out in one stroke. This single continuous stroke movement allows a quick assembly process per assembly portion.

The foils 1, 2 each have a thickness in the range larger than 0 μm to approx. 300 μm. The projections 3a-c of the microstructure have a height less than 1 mm. In order to carry out the above-mentioned passing-through movement, the height of the projections 3a-c of the microstructure must be larger than the overall thickness of the two foils.

As shown in FIG. 2, the projections carry out a partial cutting process on the two foils 1, 2 when carrying out the passing-through movement. For this purpose, the projections 3a-c have the already mentioned cutting edges. According to the embodiment, the cutting process through each of the projections 3a-c is carried out along two parallel straight lines. By this partial cutting process is the material to be displaced partially separated from the remaining foil. Thereby, the passing-through displacement of the material is facilitated. Furthermore, the transverse squeezing of the displaced material of the foils into the carrier foil is not obstructed along the cutting edges so that the undercut is formed with a low expenditure of energy and in a reliable manner. The connection of the displaced material of the foil or undercut portion with the remaining foil 1, 2 is maintained through the uncut web portion, as is shown in FIG. 2.

When assembling the two foils 1, 2, the above described assembly process is carried out successively for a plurality of assembly portions or it is carried out simultaneously by means of a device with a plurality of assembly dies. The assembly portion has a size of approx. 1 mm². The simple stroke movement and the cooperation of the projections with a simple planar counterholder allows a reliable assembly within a short process time.

In the above described apparatus and in the method, the assembly of two foils 1, 2 is shown. This apparatus and this method are also suitable for assembling foil sections that are connected to components.

In the above described apparatus and in the method, the carrier foil 5 is described as the third foil of the foil package. This carrier foil 5 is, depending on the field of use, formed as a lost auxiliary member which is removed (drawn off) after the assembly of the foils 1, 2, or, formed as a product member of the assembled foils, which remains on the foils. It is essential for the carrier foil 5 that this foil is made of an elastic and/or plastically deformable material to receive the displaced material of the foils 1 2, squeezed in the transverse direction.

Depending on the intended use, the carrier foil 5 may be made of paper, plastics or metal. Furthermore, the carrier foil can be made of a compound of the above-mentioned materials. The carrier foil 5 is uncoated or coated. The carrier foil 5 has a thickness in a range larger than 0 μm up to approx. 300 μm. The thickness of the carrier foil 5 may be equal or unequal to the respective thickness of the foils 1, 2.

Depending on the intended use and embodiment, the carrier foil 5 may be connected before assembly with the first foil 1 by adhesion and/or welding. As an alternative, the first foil 1 is coated with the carrier foil 5.

The foils 1, 2 or foil sections used consist of paper, plastics or metal or are made of a compound of these materials. Moreover, uncoated or coated foils or foil sections can be assembled. The assembly method can also be applied to foils having a sandwich structure.

Each of the foils 1, 2 or foil sections has a thickness in a range larger than 0 μm to approx. 300 μm. Foils of an identical or different thickness can be assembled.

Depending on the intended use and embodiment, the foils can be connected to each other in an adhesive manner in some portions before assembly, particularly by adhesion and/or welding. The assembly therefore additionally supplies a positive connection.

The assembled foils are used for instance in the field of radio frequency identification as so-called RFID-data carriers in the form of RFID labels, which consists of a flexible antenna substrate with a metal coating and pre-mounted RFID chips on metal foil bridges. If a respective application is required, the first foil 1 can have an electrically conductive layer and the second foil 2 can also have an electrically conductive layer. The electrically conductive layer of the first foil and the electrically conductive layer of the second foil are insulated against each other e.g. by a (further) insulating foil. An electrical contact between the electrically conductive layer of the first foil and the electrically conductive layer of the second foil is created by clinching in the assembly portion of the first and the second foil 1, 2. Thus, strip conductors can specifically be connected to each other on the foils.

By means of the method for assembling foils, connections for micro-system technology, precision technology, electronics and electro-technics can be produced for a large variety of materials. The use of foils having a different thickness is possible. Material combinations are possible (also with plastics and with plastics layers). The assembly of two foils is shown. A plurality of foils can be connected to each other by the method.

A surface pre-treatment of the components to be assembled is not necessary by the method. Additional materials or auxiliary components such as rivets etc. are not required. A post-treatment or post-processing is not required. No heat is conducted into the assembly components when using the described method.

The method reveals a high economic efficiency and process stability. Clock cycles far below one second are possible. The method can be combined with further methods (e.g. adhesion).

The embodiment describes a method of assembling at least two components 1, 2 which rest on each other at least in an assembly portion. A carrier element 5 is in contact with a first 1 one of the two components 1, 2 at least in the assembly portion. At least one projection 3a passes through the components 1, 2 in the assembly portion in the direction towards the carrier element 5. The carrier element 5 is planarly supported against the passing-through movement of the projection at least in the assembly portion.

The passing of the projection 3a-c through the components 1, 2 and the opposed planar support of the carrier element 5 effect a plastic deformation of the passed-through material of the components 1, 2 in a direction transversely to the passing-through movement of the projection 3a-c by deforming the carrier element 5.

In the method for assembling at least two components, the projection 3a-c penetrates into a second component 2. The material of the second component 2 is displaced towards the first component 1. By the passing-through movement of the projection 3a-c, material of the first component 1 is displaced towards the carrier element 5. The displaced material of the first and the second component 1, 2 substantially penetrates into the carrier element 5. The plastic deformation of the material of the components 1, 2 passed through forms an undercut portion with the first and second component transversely to the passing-through movement.

The projection 3a-c according to the embodiment carries out a partial cutting process at both components 1, 2 along at least one line during the passing movement through the components 1, 2. This cutting process is carried out along at least one straight line, and according to the embodiment along two parallel straight lines for a projection. The passing-through movement of the projection 3a-c is carried out in one single continuous stroke movement.

In the assembling method described, the planar support of the carrier element 5 is carried out in a plane, particular across a large surface.

According to the embodiment, the above-mentioned components are at least a first and a second foil 1, 2 or comprise at least a first and a second foil section, which rest on each other at least in the assembly portion. These first and second foils 1, 2 or first and second foil sections rest on each other across a large surface.

The foils 1, 2 or foil sections may have paper and/or plastics and/or metal. Furthermore, the foils 1, 2 or foil sections may be uncoated or coated and/or have a sandwich structure. The foils 1, 2 or foil sections according to the embodiment each have a thickness in a range larger than 0 μm to approx. 300 μm. Before assembly the first and the second foil 1, 2 may be connected in a manner adhering to each other at least on some portions, particularly by adhesion and/or welding.

According to a preferred field of use, the first foil 1 and the second foil 2 each have an electrically conductive layer. The electrically conductive layer of the first foil 1 and the electrically conductive layer of the second foil may first of all be electrically insulated against each other if the respective application is required. The passing-through movement of the projection 3a-c in the assembly portion of the first and second foil 1, 2 provides an electrical contact between the electrically conductive layer of the first foil 1 and the electrically conductive layer of the second foil 2.

The carrier element consists of an elastic and/or plastically deformable material and is formed as a carrier foil 5, which at least in the assembly portion contacts the first foil 1. According to the embodiment, the first foil 1 and the carrier foil 5 rest on each other over a large surface.

The carrier foil 5 has paper and/or plastics and/or metal, wherein the carrier foil 5 may be uncoated or coated and/or may have a sandwich structure. The carrier foil 5 has a thickness in a range larger than 0 μm to approx. 300 μm, and it may be connected before assembly with the first foil 1 at least in some portions adhesive, particularly by adhesion and/or welding. As an alternative, the first foil 1 can be coated with the carrier foil 5 at least in the assembly portion.

The embodiment described further comprises an apparatus for assembling at least two components. These components rest on each other at least in an assembly portion. This apparatus comprises at least one projections 3a-c and an opposed counterholder 4, wherein the projection 3a-c for passing through the components 1, 2 is provided in the assembly portion. A carrier element 5 is provided between a first one 1 of the two components 1, 2 and the counterholder and contacts the first component (1) and the counterholder (4) at least in the assembly portion. The counterholder (4) planarly supports the carrier element 5 at least in the assembly portion against the passing-through movement of the projection 3a-c. The passing of the projection 3a-c through the components 1, 2 and the opposed planar support of the carrier element effects the plastic deformation of the material of the components 1, 2 passed through in a direction transversely to the relative movement of the projection 3a-c by deforming the carrier element 5.

The assembly portion has a size of approx. 1 mm², wherein the projections 3a-c are formed as a microstructure on an assembly die (6) or a counterholder. The microstructure has a width and a height of less than 1 mm. The projection is 3a-c formed in a web-shaped manner, wherein a plurality, particularly 3, of projections (3a-c) for one single assembly portion for the parallel passing-through of material are provided. These web-shaped projections 3a-c are provided in parallel to each other for one single assembly portion.

1. A method for assembling at least two components, which are brought to contact each other at least in an assembly portion, wherein
a carrier element rests on a first one of the two components,
at least one projection passes through the components in the assembly portion in the direction towards the carrier element,
the carrier element is planarly supported at least in the assembly portion against the passing-through movement of the projection, and the passing of the projection through the components and the opposed planar support of the carrier element effects a plastic deformation of the passed-through material of the components in the direction transversely to the passing-through movement of the projection by deforming the carrier element.

2. A method for assembling at least two components as claimed in claim 1, wherein the carrier element consists of an elastically and/or plastically deformable material.

3. A method for assembling at least two components as claimed in claim 1, wherein
the projection penetrates into a second component and displaces material of the second component in the direction towards the first component,
material of the first component is displaced in the direction towards the carrier element,
the displaced material of the first and of the second component substantially penetrates into the carrier element, and wherein
the plastic deformation of the passed-through material of the components transversely to the passing-through direction forms an undercut portion with the first and the second component.

4. A method for assembling at least two components according to claim 1, wherein
the projection, during the passing movement through the components, carries out a partial cutting process at both components along at least one line, and wherein
the cutting process is carried out along at least one straight line.

5. A method for assembling at least two components as claimed in claim 1, wherein
the passing-through movement of the projection is implemented in one single continuous stroke movement and/or that the planar support of the carrier element is carried out in a plane, and wherein
the support of the carrier element is implemented in a large surface.

6. A method for assembling at least two components as claimed in claim 1, wherein
the components are at least a first and a second foil or comprise at least a first and a second foil section, which rest on each other at least in the assembly portion,
and wherein the first and the second foil or the first and the second foil section contact each other on a large surface, and/or the foils or the foil sections comprise paper and/or plastics and/or metal, and/or the foils or the foil sections are uncoated or coated and/or have a sandwich structure.

7. A method for assembling at least two components as claimed in claim 6, wherein the foils and the foil sections each have a thickness in the range larger than 0 μm to approx. 300 μm and/or that before assembly the first and the second foil are connected to each other in a manner adhering at least partially to each other, particularly by adhesion and/or welding.

8. A method for assembling at least two components as claimed in claim 6, wherein
the first foil comprises an electrically conductive layer and the second foil comprises an electrically conductive layer,
the electrically conductive layer of the first foil and the electrically conductive layer of the second foil are electrically insulated against each other, and an electrical contact between the electrically conductive layer of the first foil and wherein
the electrically conductive layer of the second foil is created by the passing-through movement of the projection in the assembly portion of the first and second foil.

9. A method for assembling at least two components according to claim 6, wherein the carrier element consists of a carrier foil, which at least in the assembly portion thereof contacts the first foil, and wherein the first foil and the carrier foil contact each other on a large surface.

10. A method for assembling at least two components as claimed in claim 9, wherein
the carrier foil comprises paper and/or plastics and/or metal, and/or the carrier foil is uncoated or coated and/or has a sandwich structure, and wherein
the carrier foil has a thickness in a range larger than 0 μm to approx. 300 μm.

11. A method for assembling at least two components as claimed in claim 9, wherein, before assembly, the carrier foil is connected to the first foil in an at least partially adhesive manner by adhesion and/or welding, and/or that the first foil is coated with the carrier foil at least in the assembly portion.

12. A method for assembling at least two components as claimed in claim 6, wherein the assembly portion of the first and second foil has a size of approx. 1 mm².

13. A method for assembling at least two components according to claim 6, wherein the projection is formed as a microstructure on an assembly die or a counterholder, wherein the microstructure has a width and a height of less than 1 mm, and/or that the projection is formed in a catwalk-shaped manner.

14. A method for assembling at least two components as claimed in claim 6, wherein a plurality of projections is provided for one single assembly portion for parallelly passing through material, at least two web-shaped projections are provided in parallel to each other for one single assembly portion.

15. A method for assembling at least two components as claimed in claim 1, wherein the introduction of power onto the projections is carried out abruptly through a die and/or counterholder.

16. An apparatus for assembling at least two components which are brought to rest on each other at least at an assembly portion, comprising:
at least one projection and an opposed counterholder, wherein
the projection is provided in the assembly portion,
a carrier element between a first one of the two components and the counterholder is provided and contacts the first component and
the counterholder at least in the assembly portion, and the counterholder is provided for planarly supporting the carrier element at least in the assembly portion against the passing-through movement of the projection, and the passing of the projection through the components and the opposed planar support of the carrier element effects a plastic deformation of the passed-through material of the components in the direction transversely to the relative movement of the projection by deforming the carrier element.

17. An apparatus for assembling at least two components as claimed in claim 16, wherein
the projection (3a-c)is movable relative in the direction towards the counterholder and comprises at least one cutting edge, to carry out a partial cutting process at both components along at least one line during the passing movement through the components, wherein
the cutting edge is a straight line and/or wherein the projection comprises two parallel cutting edges.

18. An apparatus for assembling at least two components as claimed in claim 16, wherein
the counterholder is formed as a planar counterholder plate, which can be contacted with the carrier element, and/or wherein
the carrier element consists of an elastically and/or plastically deformable material.

19. An apparatus for assembling at least two components as claimed in claim 16, wherein
the components are at least a first and a second foil, or comprise at least a first and a second foil section, which contact each other at least in the assembly portion,
the carrier element consists of a carrier foil which contacts the first foil at least in the assembly portion, and wherein
the carrier foil comprises paper and/or plastics and/or metal, and is uncoated or coated and/or has a sandwich structure, and/or has a thickness in a range larger than 0 μm to approx. 300 μm.

20. An apparatus for assembling at least two components as claimed in claim 16, wherein,
the projection is formed as a microstructure on as movable assembly die or the counterholder,
the movable assembly die is guided in a downholder, and/or wherein,
the microstructure has a width and a height of less than 1 mm and/or the assembly portion has a size of approx. 1 mm².

21. An apparatus for assembling at least two components as claimed in claim 16, wherein,
the projection is formed in a web-like manner with the projections begin provided for one single assembly portion for parallelly passing through material, and wherein
three web-shaped projections are provided in parallel to each other for one single assembly portion.
